(19) United States
(12) Patent Application Publication
(10) Pub. No.: US 2007/0150593 A1
(43) Pub. Date: Jun. 28, 2007

(54) NETWORK PROCESSOR AND REFERENCE COUNTING METHOD FOR PIPELINED PROCESSING OF PACKETS

(75) Inventor: Abhishek Singh, Pleasanton, CA (US)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/275,360

(22) Filed: Dec. 28, 2005

(51) Int. Cl. G06F 15/173

(52) U.S. Cl. 709/226

(57) ABSTRACT

A network processor and a deterministic method are described herein that can prevent a dataplane malfunction within a packet processing pipeline by delaying a configuration manager from being able to immediately re-use entries which have been freed-up/deleted from shared memory.

### BACKGROUND OF THE INVENTION

1. Field of the Invention

The present invention relates to a network processor and a deterministic method for preventing a dataplane malfunction within a packet processing pipeline by delaying a configuration manager from being able to immediately re-use entries which have been freed-up/deleted in shared memory.

2. Description of Related Art

Referring to FIG. 1 (PRIOR ART), there is a block diagram illustrating the basic components of a traditional network processor 100 (e.g., Intel® (IP XXXX Network Processor). The traditional network processor 100 includes a configuration manager/control processor 102, a shared memory 104 (forwarding information base (FIB) 104) and a packet processing pipeline 106. Basically, the configuration manager 102 (which operates in a management/control plane) populates and manages/modifies the shared memory 104. And, the shared memory 104 has a table 108 which contains a freelist 110 and multiple arrays 112a, 112b, 112c, 112d and 112e (for example). The packet processing pipeline 106 (which operates in a dataplane) receives packets 114 and does some classification or lookup in the shared memory 104 to obtain state information/packet meta-data from the arrays 112a, 112b . . . 112e. A more detailed description is provided next about how the packet processing pipeline 106 operates to process the packets 114.

The packet processing pipeline 106 divides packet processing into stages and dedicates an individual processor 116a, 116b . . . 106h (or individual block 116a, 116b . . . 106h) for each stage in the pipeline so it is able to process packets 114 at a very high speed. In particular, each block 116b (for example) is able to receive and process a packet 114 and then pass that packet 114 to a downstream block 116c (for example) which has just processed a previous packet 114 and passed that packet 114 to another block 116d (for example) and so on. And, each block 116a, 116b . . . 116h processes a packet 114 by performing some classification or lookup within table 108 and producing some state information (packet meta-data). The packet meta-data is passed along with the packet 114 from one block 116b (for example) to another block 116c (for example). Then, this block 116c (for example) processes the packet 114 by using the corresponding packet meta-data to perform some additional classification/table look-up to produce some more state information (packet meta-data) or to update some state such as a “counter for packets dropped on a given interface”. An example of a packet processing pipeline 106 which is implementing a router application is discussed next.

In this exemplary routing application, the packet processing pipeline 106 has an ingress path 107 that receives a packet 114 at Rx block 116a which passes that packet 114 to the Layer-2 Decap/MPLS block 116b. The Layer-2 Decap/MPLS block 116b refers to Layer-2 Decap Array 112a within the shared memory 104 and obtains an Ingress Vlf Id which is stored as packet meta-data within packet 114. The purpose of stashing the Ingress Vlf Id as packet meta-data is that a downstream block 116c (for example) needs to use it for their processing.

At the IPv4/IPv6 lookup block 116c, a table look-up is performed within an IP lookup array 112b to obtain a next hop id. In particular, the IPv4/IPv6 lookup block 116c uses the Ingress Vlf ID packet meta-data, and produces the destination IP address, and obtains the next hop Id packet meta-data. The destination IP address is produced by header extraction, while the next hop Id packet meta-data is obtained as a result of the lookup of the IP lookup array 112b. Again, the intent of stashing the next hop Id meta-data in packet 114 is that a downstream block 116d (for example) needs to use it for their processing.

At the first Diffserv/Policy lookup block 116d, a 5 tuple is looked up in a policy lookup table 112c which can potentially override the next hop ID that was obtained by the route lookup in the IP lookup array 112b. Then, in the egress path 109, the second Diffserv/Policy lookup block 116e (which can perform another policy lookup and does other things like shaping) forwards the packet 114 to the next hop block 116f which uses the next hop Id packet meta-data and performs a lookup in the Next Hop array 112d to obtain the next hop IP address and the Egress Vlf Id. In the Next Hop array 112d, the next hop Id is the input packet meta-data while the next hop IP address and the Egress Vlf Id are the output packet meta-data.

At the L2 Encap block 116g, a table lookup is performed in the ARP array 112e to obtain a destination MAC address. The L2 Encap block 116g uses the Egress Vlf Id packet meta-data and the next hop IP address packet meta-data to obtain the destination MAC address. The destination MAC address is not packet meta-data because there is no need to stash its value for use by the TX block 116h. It should be noted that this router application is just one of many possible applications that can be implemented by the traditional network processor 100. And, it was provided to help describe a problem that is associated with the traditional network processor 100.

As mentioned above, the configuration manager 102 populates and maintains/modifies the arrays 112a, 112b . . . 112f within table 108. The configuration manager 102 modifies one or more of the arrays 112a, 112b . . . 112f when there is a configuration change or when there is a change caused by routing protocols (located in the management plane). There are primarily two kinds of changes: (1) table_entry_add( ); and (2) table_entry_delete( ). The table_entry_delete( ) results in the deletion of an entry within an array 112a, 112b . . . 112f and the freeing-up of a row in that particular array 112a, 112b . . . 112f. The configuration manager 102 places the deleted entry within the freelist 110 (first in first out (FIFO) data structure 110). And, the next time, the configuration manager 102 performs a table_entry_add( ) operation it will re-use one of the deleted entries located in the freelist 110.

Because, the configuration manager 102 can immediately re-use deleted entries which have been placed within the freelist 110, there is a potential to have a dataplane malfunction within the packet processing pipeline 106. In particular, if the configuration manager 102 deletes an entry from one of the arrays 112a, 112b . . . 112f, places the deleted entry within the freelist 110, and immediately takes that deleted entry from the freelist 110 and re-uses it for something else within one of the arrays 112a, 112b . . . 112f. Then, it can be seen that in this situation one of the blocks 116a, 116b . . . 116h could process a packet 114 and use it's packet meta-data to refer to an entry within one of the arrays 112a, 112b . . . 112f that has taken on a new meaning when it should have retained it's old meaning. For example, assume block 116c receives packet 114 and looks-up array 112b the result of which is a pointer to an entry in array 112d. Now, when block 116f gets to act on that packet 114, the entry in array 112b could have assumed a new meaning. Thus, the immediate re-use of deleted entries can cause the mishandling of packets 114 which are in-flight within the packet processing pipeline 106. This dataplane malfunction happens because the configuration manager 102 operates on the management/control plane which is independent and distinct from the dataplane operations of the packet processing pipeline 106.

One possible solution to this problem is to not re-use any packet meta-data that gets freed-up by the configuration manager 102 for “some time”. However, this solution is not very deterministic in that it can lead to the same problem if “some time” is too short or it can lead to artificial shortages if “some time” is too long. Another possible solution to this problem is to have some kind of reference counting for every packet meta-data. However, this solution is not very practicable or scalable. In addition, this solution can waste precious packet processing cycles and result in a drag on the performance of the network processor 100. Accordingly, there has been and is a need to address the dataplane problem associated with the traditional network processor 100. This problem and other problems are solved by the present invention.

### BRIEF DESCRIPTION OF THE INVENTION

The present invention is related to a network processor and a deterministic method that can prevent a dataplane malfunction within a packet processing pipeline by delaying a configuration manager from being able to immediately re-use entries which have been freed-up/deleted from a table in shared memory. To accomplish this, the configuration manager places the freed-up entries within an intermediate freelist instead of a traditional freelist(s) to prevent itself from re-using any of the freed-up entries until there are no longer any packets located (or in-flight) within the packet processing pipeline which hold a reference to the intermediate freelist. Once, there are there are no longer any of these packets located within the packet processing pipeline, then the configuration manager removes the freed-up entries from the intermediate freelist and places them into the traditional freelist(s). Now, the configuration manager is able to take the freed-up entries from the traditional freelist(s) and re-use them within the table in shared memory.

### BRIEF DESCRIPTION OF THE DRAWINGS

A more complete understanding of the present invention may be had by reference to the following detailed description when taken in conjunction with the accompanying drawings wherein:

FIG. 1 (PRIOR ART) is a block diagram illustrating the basic components of a traditional network processor;

FIG. 2 is a block diagram illustrating the basic components of a network processor in accordance with the present invention;

FIG. 3 is a flow diagram illustrating the basic steps of a deterministic method in accordance with the present invention, and

FIG. 4 is a diagram used to further help explain some of the features and capabilities of the network processor in accordance with the present invention.

### DETAILED DESCRIPTION OF THE DRAWINGS

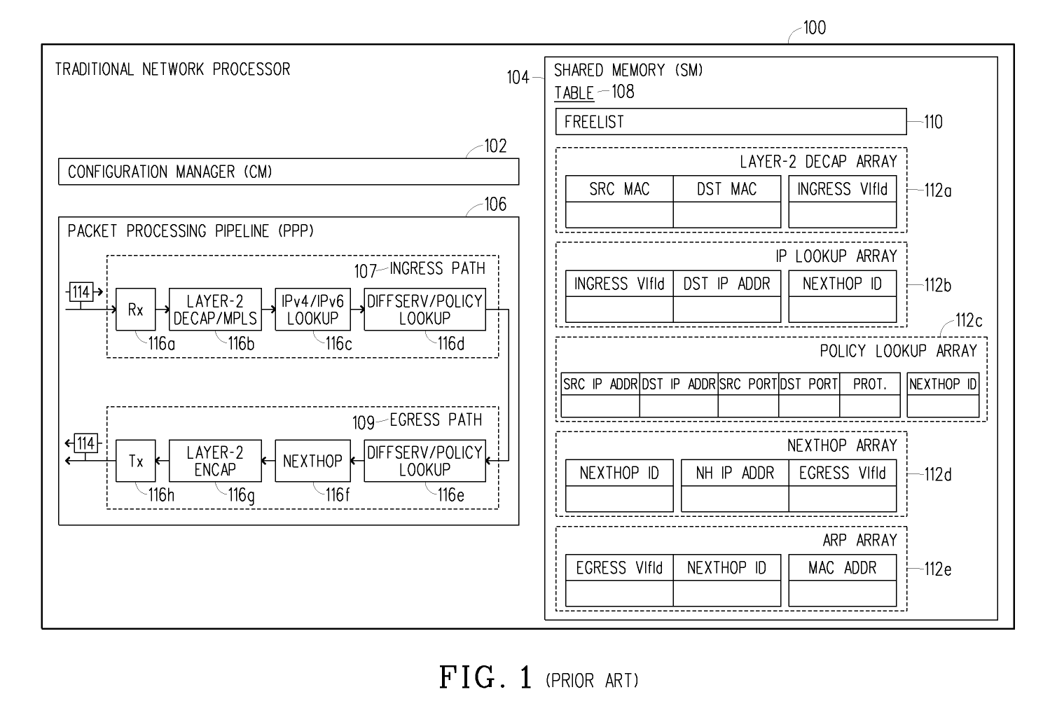

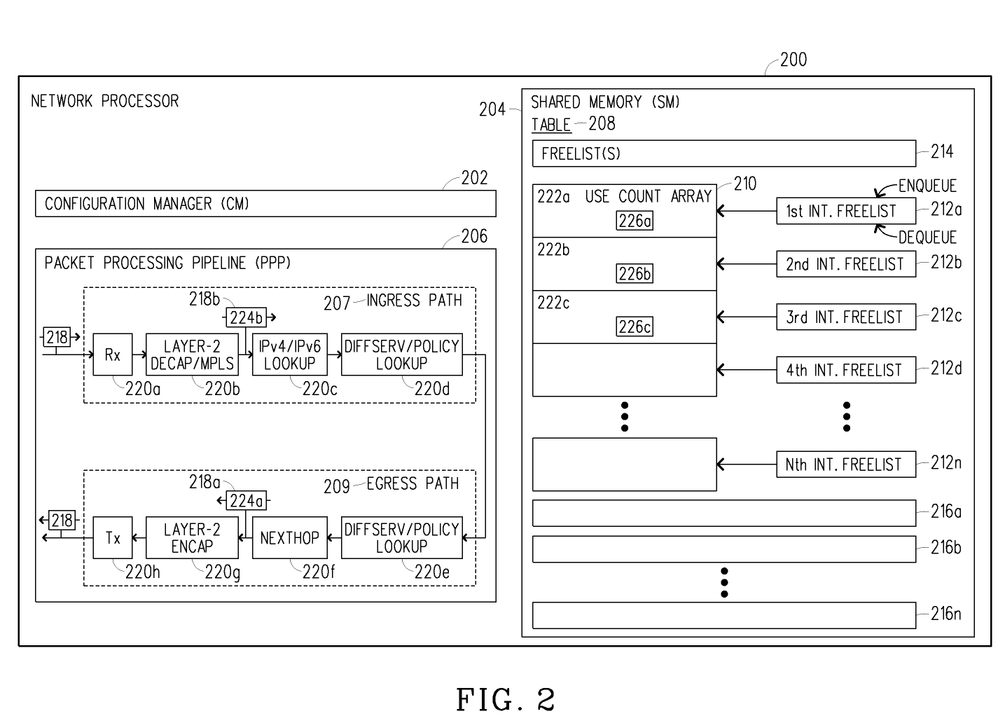

Referring to FIG. 2, there is a block diagram illustrating the basic components of a network processor 200 in accordance with the present invention. The network processor 200 includes a configuration manager/control processor 202, a shared memory/FIB 204 and a packet processing pipeline 206. Basically, the configuration manager 202 (which operates in a management/control plane) populates and manages/modifies the shared memory 204. And, the shared memory 204 has a table 208 which contains a use count array 210, intermediate freelist(s) 212a, 212b . . . 212n, “traditional” freelist 214, and multiple arrays 216a, 216b . . . 216n (compare to FIG. 1). The packet processing pipeline 206 (which operates in a dataplane) receives packets 218 and does some classification or lookup in shared memory 204 to obtain state information/packet meta-data from the arrays 216a, 216b . . . 216n. A more detailed description is provided next about how the packet processing pipeline 206 operates to process the packets 218.

The packet processing pipeline 206 (which happens to have the same configuration as the exemplary pipeline 106 shown in FIG. 1) divides packet processing into stages and dedicates an individual processor 220a, 220b . . . 220h (or individual block 220a, 220b . . . 220h) for each stage in the pipeline so it is able to process packets 218 at a very high speed. In particular, each block 220b (for example) is able to receive and process a packet 218 and then pass that packet 218 to a downstream block 220c (for example) which has just processed another packet 218 and passed that packet 218 to another block 220d (for example) and so on. And, each block 220a, 220b . . . 220h processes a packet 218 by performing some classification or lookup within table 208 and producing some state information (packet meta-data). Then, the packet meta-data is passed along with the packet 218 from one block 220b (for example) to another block 220c (for example). Then, this block 220c (for example) processes the packet 218 by using the corresponding packet meta-data to perform some additional classification/table look-up to produce some more state information (packet meta-data) or to update some state such as a “counter for packets dropped on a given interface”.

As mentioned above, the configuration manager 202 populates and maintains/modifies the arrays 216a, 216b . . . 216n within table 208. The configuration manager 202 modifies one or more of the arrays 216a, 216b . . . 216n when there is a configuration change or when there is a change caused by routing protocols (located in the management plane). There are primarily two kinds of changes: (1) table_entry_add( ); and (2) table_entry_delete( ). The table_entry_delete( ) results in the deletion of an entry within one of the arrays 216a, 216b . . . 216n and the freeing-up of a row in that particular array 216a, 216b . . . 216n. In the past, the traditional configuration manager 102 placed the deleted entry within the freelist 110 so it could immediately re-use the deleted entry which as discussed above can cause a dataplane malfunction within the packet processing pipeline 106 (see FIG. 1). The present invention addresses this problem by enabling the packet processing pipeline 206 to work off an “old” configuration in shared memory 204 and allow for some delay before a “new” configuration in shared memory 204 can take effect. How this is done is described next.

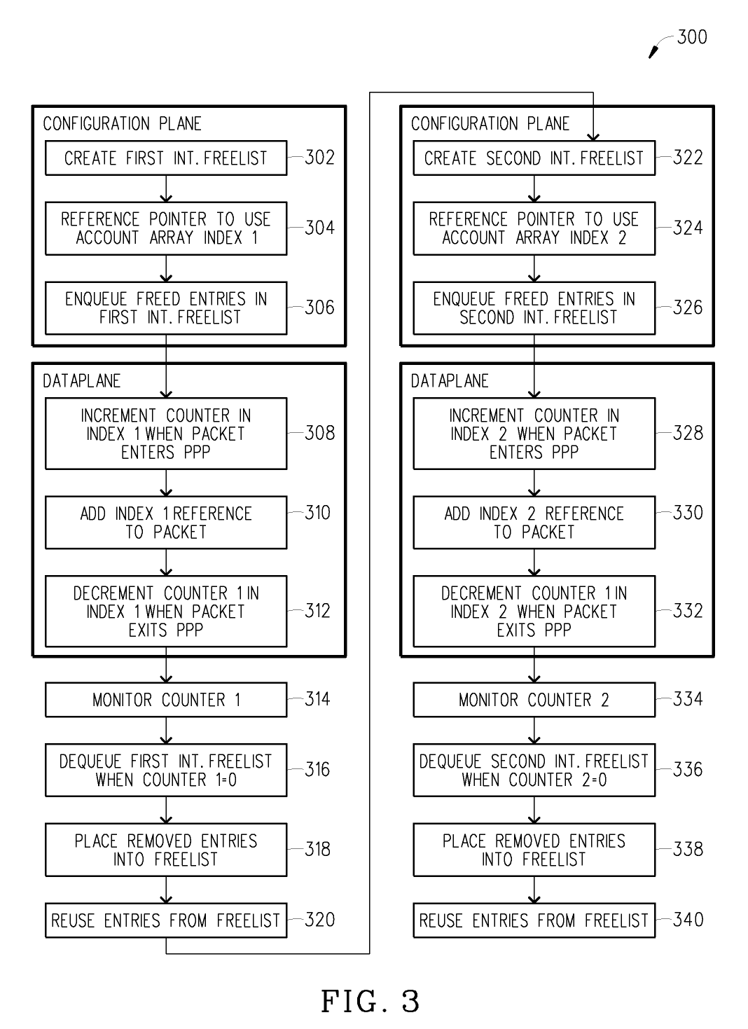

Basically, the configuration manager 202 prevents a dataplane malfunction by delaying the re-use of entries that have been freed-up/deleted from table 208. To accomplish this, the configuration manager 202 places the freed-up entries within an intermediate freelist 212a (for example) instead of within a traditional freelist(s) 214. Then, the configuration manager 202 is not permitted to re-use the freed-up entries placed in the intermediate freelist 212a (for example) until there are no longer any packets 218 located (or in-flight) within the packet processing pipeline 206 which hold a reference to the intermediate freelist 212a (for example). Once, there are there are no longer any of these packets 218 located within the packet processing pipeline 206, then the configuration manager 202 removes the freed-up entries from the intermediate freelist 212a (for example) and places them into the traditional freelist(s) 214. At this point, the configuration manager 202 can take the freed-up entries from the traditional freelist(s) 214 and re-use them within table 208. A detailed discussion about a preferred way that this process can be implemented by the network processor 200 is provided below with respect to FIG. 3.

Referring to FIG. 3, there is a flow diagram illustrating the basic steps of a deterministic method 300 that is implemented by the network processor 200 in accordance with the present invention. As shown, the configuration manager 202 creates (step 302) a first intermediate freelist 212a (FIFO queue data structure 212a) which is located within the shared memory 204 (see FIG. 2). Upon creating the first intermediate freelist 212a, the configuration manager 202 references (step 304) a pointer to a first index 222a in the use count array 210 which is associated with the first intermediate freelist 212a. The configuration manager 202 then places/enqueues (step 306) the entries that are freed-up/deleted from array(s) 216a, 216b . . . 216n into the first intermediate freelist 212a. The configuration manager 202 is not able to re-use any of these freed-up entries until there are no longer any packets 218a located (or in-flight) within the packet processing pipeline 206 which hold a reference 224a to the first intermediate freelist 212a. A discussion is provided next with respect to steps 308, 310, 312 and 314 to describe how the configuration manager 202 knows when there are no longer any packets 218a which hold reference 224a still located (or in-flight) within the packet processing pipeline 206.

First, the packet processing pipeline 206 increments (step 308) a counter 226a within the first index 222a of the use count array 210 which is associated with the first intermediate freelist 212a whenever a packet 218a enters the packet processing pipeline 206 while the configuration manager 202 is configured to place freed-up entries within the first intermediate freelist 212a (see FIG. 2). At this time, the packet processing pipeline 206 also adds (step 310) the first index reference 224a (which is packet meta-data) to each packet 218a that enters the packet processing pipeline 206 while the configuration manager 202 is configured to place freed-up entries within the first intermediate freelist 212a.

At the same time, the packet processing pipeline 206 decrements (step 312) the counter 226a within the first index 222a of the use count array 210 which is associated with the first intermediate freelist 212a whenever a packet 218a with reference 224a exits the packet processing pipeline 206. During steps 308, 310 and 312, the configuration manager 202 also monitors (step 314) the counter 226a and when the counter 226a reaches zero then it removes/dequeues (step 316) the freed-up entries from the first intermediate freelist 212a. The configuration manager 202 can remove the freed-up entries from the first intermediate freelist 212a because there are no longer any packets 218a which hold reference 224a still located (or in-flight) within the packet processing pipeline 206.

The configuration manager 202 then places (step 318) the removed entries into the appropriate traditional freelist 214 (FIFO queue data structure 214a). For instance, if a removed entry is associated with routing then it would be placed in a routing traditional freelist 214. Or, if a removed entry is associated with interfacing then it would be placed in an interface traditional freelist 124. At this point, the configuration manager 202 can re-use (step 320) one of the entries located in the traditional freelist 214 whenever it implements a table_entry_add( ). Of course, it is not desirable for the first intermediate freelist 212a to contain a large number of freed-up entries. Because, the configuration manager 202 cannot re-use those freed-up entries until they are placed in the traditional freelist 214.

To address this need, the configuration manger 202 can create (step 322) a second intermediate freelist 212b whenever the number of freed-up entries placed within the first intermediate freelist 212a exceeds a predetermined threshold. Upon creating the second intermediate freelist 212b, the configuration manager 202 references (step 324) the pointer to a second index 222b in the use count array 210 which is associated with the second intermediate freelist 212b (see FIG. 2). The configuration manager 202 then places/enqueues (step 326) the entries that are subsequently deleted from array(s) 216a, 216b . . . 216n into the second intermediate freelist 212b. Again, the configuration manager 202 is not able to re-use any of these freed-up entries until there are no longer any packets 218b located (or in-flight) within the packet processing pipeline 206 which hold a reference 224b to the second intermediate freelist 212b. A discussion is provided next with respect to steps 328, 330, 332 and 334 to describe how the configuration manager 202 knows when there are no longer any packets 218b which hold reference 224b still located (or in-flight) within the packet processing pipeline 206.

First, the packet processing pipeline 206 increments (step 328) a counter 226b within the second index 222b of the use count array 210 which is associated with the second intermediate freelist 212b whenever a packet 218b enters the packet processing pipeline 206 while the configuration manager 202 is configured to place freed-up entries within the second intermediate freelist 212b (see FIG. 2). At this time, the packet processing pipeline 206 also adds (step 330) the second index reference 224b (which is packet meta-data) to each packet 218b that enters the packet processing pipeline 206 while the configuration manager 202 is configured to place freed-up entries within the second intermediate freelist 212b.

At the same time, the packet processing pipeline 206 decrements (step 332) the counter 226b within the second index 222b of the use count array 210 which is associated with the second intermediate freelist 212b whenever a packet 218b with reference 224b exits the packet processing pipeline 206. During steps 328, 330 and 332, the configuration manager 202 also monitors (step 334) the counter 226b and when the counter 226b reaches zero then it removes/dequeues (step 336) the freed-up entries from the second intermediate freelist 212b (note that the configuration manager 202 may also at this time still be monitoring the counter 226a associated with the first intermediate freelist 212a). The configuration manager 202 can remove the deleted entries from the second intermediate freelist 212b because there are no longer any packets 218b which hold reference 224b still located (or in-flight) within the packet processing pipeline 206.

The configuration manager 202 then places (step 338) the removed entries into the appropriate traditional freelist 214. At this point, the configuration manager 202 can re-use (step 340) one of the entries located in the traditional freelist(s) 214 whenever it implements a table_entry_add( ). The configuration manager 202 can also repeat these steps many times in order to create, fill and remove freed-up entries into/from multiple intermediate freelists 212a, 212b . . . 212n. Finally, it should be noted that the intermediate freelist 212a, 212b . . . 212n activity is completely independent of the packet activity. In particular, steps 302, 304, 306, 322, 324 and 326 take place in the configuration plane and steps 308, 310, 312, 328, 330 and 332 take place in the dataplane. However, because the management/control plane's operations can indirectly affect the dataplane's operations these special measures need to be taken to ensure the dataplane correctness.

From the foregoing, it should be appreciated that the network processor 202 implements the deterministic method 300 to help ensure the correct functioning of the dataplane at all times by not allowing the immediate re-use of freed-up entries. An intermediate freelist 212a, 212b . . . 212n (FIFO) queue data structure was introduced in which the freed-up entries are put/enqueued instead of being placed on the traditional freelist(s) 214 and made available for re-use. If the number of items in the intermediate freelist 212a (for example) grows to be more than a threshold, then a new intermediate freelist 212b (for example) is created (and a reference is pointed to the next index in the use count array 210). At this point, the newly created intermediate freelist 212b is empty. But, all items freed-up from this point on are put/enqueued on the new intermediate freelist 212b. As mentioned above, this process can be repeated and multiple intermediate freelists 212c . . . 212n can be created.

The configuration manager 202 monitors the counters 226a, 226b . . . 226n in the use count array 210, and when one of the counters 226a, 226b . . . 226n goes to zero, then all the items in the corresponding intermediate freelist 212a, 212b . . . 212n are removed/dequeued and placed in the traditional freelist(s) 214 where they become eligible for re-use. This scheme makes sure that there is no packet 218a, 218b . . . 218n in the pipeline 206 which is still holding a reference 224a, 224b . . . 224n to a table entry that was freed. And, the freed table entries are released only after the number of packets 218a, 218b . . . 218n referring to them goes down to zero.

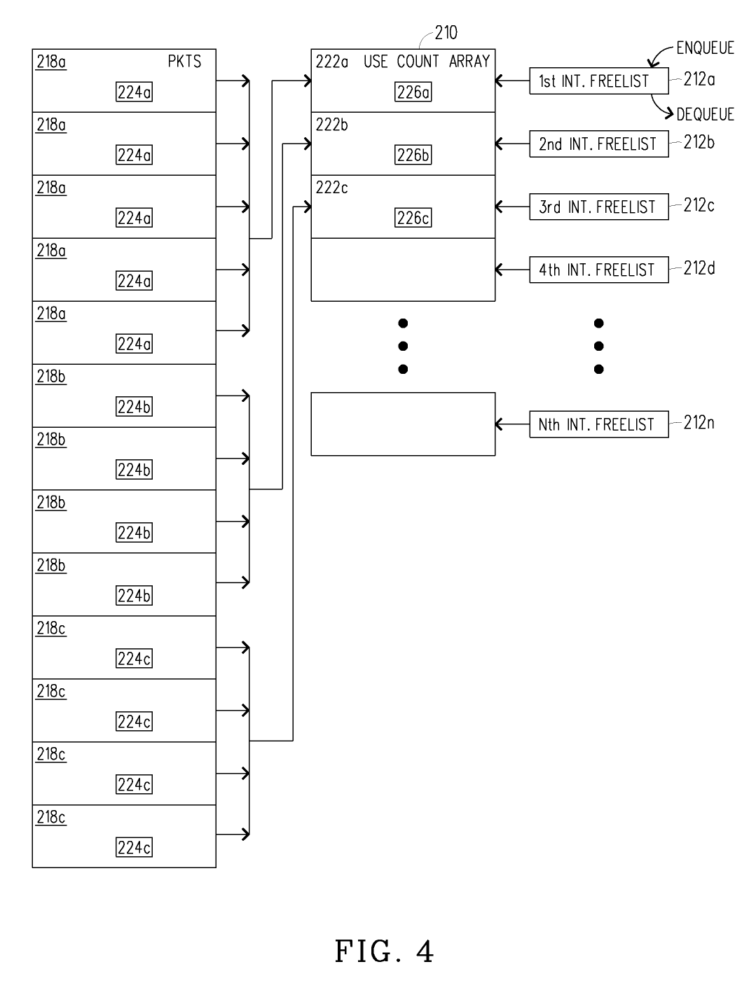

An exemplary scenario is described next with respect to FIG. 4 to further help explain the different features associated with the present invention. Assume that the first index counter 226a is zero. Then, the first 5 packets 218a come in and the reference counter 226a in the use count array 210 is incremented to 5. During this time, a lot of table entry deletes happened in the control plane (again due to configuration change, or because of routing protocols), and the number of freed-up entries in the first intermediate freelist 212a pointing to array index 1 reaches a threshold. At this point, the control plane creates the second intermediate freelist 212b and refreshes the pointer at the current use count array index 224a to point to the next use count array index 222b (in this case, two). The next four packets 218b will end up incrementing the reference counter 226b for index two in the use count array 210. Again, assume that a lot of churn happened in the control plane, and the number of freed-up items placed in the second intermediate freelist 212b pointing to index two reached a threshold. At this point, the control plane creates the third intermediate freelist 212c and refreshes the pointer at the current use count array index 222b to point to the next use count array index 222c (in this case, three). Then, the next four packets 218c will end up incrementing the reference counter 226c for index three. The scheme repeats itself in this fashion, with the use count array 210 being a circular array (i.e., goes back to index one after having gone to a maximum index).

Now, at the control plan, the first counter 226a associated with the first index in the use count array 210 is monitored until all of the first five packets 218a release their references 224a to it. At this point all the items in the first intermediate freelist 212a can be released for re-use. Similarly, when the next four packets 218b release their references 224b to the use count array index two, the second intermediate freelist 212b pointing to it can be completely dequeued and the entries can be made available for reuse. As can be seen, this scheme provides a deterministic way of freeing up table entries, and ensuring correctness.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. A network processor, comprising:
a configuration manager;
a shared memory; and
a packet processing pipeline, wherein said configuration manager deletes entries from a table within said shared memory and places the freed-up entries within a first intermediate freelist to prevent said configuration manager from re-using the freed-up entries within the table until there are no longer any packets which hold a reference to the first intermediate freelist located within said packet processing pipeline.

2. The network processor of claim 1, wherein said packet processing pipeline adds the reference which is packet meta-data to each packet that enters said packet processing pipeline while said configuration manager is still able to place freed-up entries within the first intermediate freelist.

3. The network processor of claim 2, wherein said packet processing pipeline increments a counter within a first index of a use count array associated with the first intermediate freelist whenever a packet enters said packet processing pipeline while said configuration manager is still able to place freed-up entries within the first intermediate freelist

4. The network processor of claim 3, wherein said packet processing pipeline decrements the counter within the first index of the use count array associated with the first intermediate freelist whenever one of the packets which holds the reference to the first intermediate freelist exits said packet processing pipeline.

5. The network processor of claim 4, wherein said configuration manager monitors the counter within the first index of the use count array associated with the first intermediate freelist and when the counter reaches zero the freed-up entries are released from the first intermediate freelist and placed within a freelist.

6. The network processor of claim 1, wherein said configuration manager deletes one of the entries from the table when there is a configuration change or when there is a change made by a routing protocol operating in a management plane.

7. The network processor of claim 1, wherein said configuration manager creates a second intermediate freelist and places subsequent entries that are freed-up from the table into the second intermediate freelist whenever a number of the freed-up entries that were placed within the first intermediate freelist exceeds a predetermined threshold to prevent said configuration manager from re-using the subsequent deleted entries within the table until there are no longer any packets which hold a reference to the second intermediate freelist still located within said packet processing pipeline that.

8. A method for preventing a dataplane malfunction, said method comprising the steps of:
creating a first intermediate freelist;
placing entries that are deleted from a table into the first intermediate freelist; and
preventing the freed-up entries placed within the first intermediate freelist from being re-used within the table until there are no longer any packets which hold a reference to the first intermediate freelist located within a packet processing pipeline.

9. The method of claim 8, wherein said preventing step further includes a step of adding the reference which is packet meta-data to each packet that enters the packet processing pipeline while freed-up entries could still be placed in the first intermediate freelist.

10. The method of claim 9, wherein said preventing step further includes a step of incrementing a counter within a first index of a use count array associated with the first intermediate freelist whenever a packet enters the packet processing pipeline while freed-up entries could still be placed in the first intermediate freelist.

11. The method of claim 10, wherein said preventing step further includes a step of decrementing the counter within the first index of the use count array associated with the first intermediate freelist whenever one of the packets which holds the reference to the first intermediate freelist exits the packet processing pipeline.

12. The method of claim 11, wherein said preventing step further includes a step of monitoring the counter within the first index of the use count array associated with the first intermediate freelist and when the counter reaches zero the freed-up entries are released from the first intermediate freelist and placed into one or more traditional freelists from which they can be taken and re-used within the table.

13. The method of claim 8, further comprising the steps of:
creating a second intermediate freelist whenever a number of the freed-up entries that were placed within the first intermediate freelist exceeds a predetermined threshold;
placing entries that are subsequently deleted from the table into the second intermediate freelist; and
preventing the subsequently freed-up entries placed within the second intermediate freelist from being re-used within the table until there are no longer any packets which hold a reference to the second intermediate freelist still located within said packet processing pipeline.

14. A method for preventing a dataplane malfunction said method comprising the steps of:
placing items freed from a table into a first intermediate freelist;
referencing a pointer to a first index in a use count array associated with the first intermediate freelist;
incrementing a counter within the first index in the use count array each time a packet enters a packet processing pipeline while freed-up items could still be placed into the first data structure;
adding a first index reference to each packet that enters the packet processing pipeline while freed-up items could still be placed into the first data structure;
decrementing the counter within the first index in the use count array each time one of the packets which has the first index reference exits the packet processing pipeline;
monitoring the counter within the first index in the use count array;
removing the freed-up items from the first intermediate freelist when the monitored counter indicates that there are no longer any packets which hold the first index reference still located within the packet processing pipeline;
placing the removed freed-up items into a traditional freelist; and
re-using the freed-up items that are placed into the traditional freelist within the table.

15. The method of claim 14, further comprising the steps of:
creating a second intermediate freelist whenever a number of the freed-up items that were placed in the first intermediate freelist exceeds a threshold;
placing items subsequently freed-up from the table into the second intermediate freelist;
referencing the pointer to a second index in the use count array associated with the second intermediate freelist;
incrementing a counter within the second index in the use count array each time a packet enters the packet processing pipeline while subsequently freed-up items could still be placed into the second intermediate freelist;
adding a second index reference to each packet that enters the packet processing pipeline while subsequently freed-up items could still be placed into the second intermediate freelist;
decrementing the counter within the second index in the use count array each time one of the packets which has the second index reference exits the packet processing pipeline;
monitoring the counter within the second index in the use count array;
removing the subsequent freed-up items from the second intermediate freelist when the monitored counter indicates that there are no longer any packets which hold the second index reference still located within the packet processing pipeline;
placing the removed freed-up items into the traditional freelist; and
re-using the subsequently freed-up items that are placed into the traditional freelist within the table.
